(19) United States
(12) Patent Application Publication
(10) Pub. No.: US 2024/0204224 A1
(43) Pub. Date: Jun. 20, 2024

(54) FUEL CELL VEHICLE

(71) Applicant: Isuzu Motors Limited, Yokohama-shi (JP)

(72) Inventors: Kouhei NAGAI, Fujisawa-shi (JP); Ryou ISHIDA, Fujisawa-shi (JP)

(73) Assignee: Isuzu Motors Limited, Yokohama-shi (JP)

(21) Appl. No.: 18/539,319

(22) Filed: Dec. 14, 2023

(30) Foreign Application Priority Data
Dec. 15, 2022 (JP) 2022-200138

(51) Int. Cl. H01M 8/04664; B60K 13/02; B60K 13/04; B60K 28/10; B60L 58/30

(52) U.S. Cl. CPC H01M 8/04671; B60K 13/02; B60K 13/04; B60K 28/10; B60L 58/30; H01M 2220/20

(57) ABSTRACT

A fuel cell vehicle is equipped with a tank that stores fuel, a fuel cell system that generates electric power using the fuel, and a motor that is driven using the electric power generated by the fuel cell system, the fuel cell vehicle being configured to travel by driving of the motor, the fuel cell vehicle including: a guide member configured to guide an airflow such that the airflow passes through a component at high risk of leakage of the fuel, the airflow flowing through a vehicle body of the fuel cell vehicle.

### CROSS REFERENCE TO RELATED APPLICATIONS

This application claims the benefit of priority of Japanese Patent Application No. 2022-200138, filed on Dec. 15, 2022, the contents of which are incorporated by reference as if fully set forth herein in their entirety.

### TECHNICAL FIELD

The present disclosure relates to a fuel cell vehicle.

### BACKGROUND ART

A Fuel Cell Vehicle (FCV) is known in which a tank for storing fuel (e.g., hydrogen, etc.), a fuel cell system for generating electric power using the fuel, and a motor for driving using the electric power generated by the fuel cell system are mounted and which is driven by driving of the motor.

### CITATION LIST

### Patent Literature

### PTL 1

### Japanese Patent Application Laid-Open No. 2009-170209

### SUMMARY OF INVENTION

### Technical Problem

Fuel cell vehicles are desired to efficiently discharge fuel to the outside of the vehicle in case of fuel leakage.

An object of one aspect of the present disclosure is to provide a fuel cell vehicle capable of efficiently discharging leaked fuel to the outside of the vehicle.

### Solution to Problem

In order to achieve the above object, a fuel cell vehicle according to one aspect of the present disclosure is a fuel cell vehicle equipped with a tank that stores fuel, a fuel cell system that generates electric power using the fuel, and a motor that is driven using the electric power generated by the fuel cell system, the fuel cell vehicle being configured to travel by driving of the motor, the fuel cell vehicle including: a guide member configured to guide an airflow such that the airflow passes through a component at high risk of leakage of the fuel, the airflow flowing through a vehicle body of the fuel cell vehicle.

### Advantageous Effects of Invention

According to the present disclosure, it is possible to efficiently discharge leaked fuel to the outside of a vehicle.

### BRIEF DESCRIPTION OF DRAWINGS

FIG. 1 is a schematic diagram illustrating an example of a truck according to an aspect of an embodiment of the present disclosure;

FIG. 2 is a schematic diagram illustrating an example of a truck according to an aspect of an embodiment of the present disclosure;

FIG. 3 is a schematic diagram illustrating an example of a bus according to an aspect of a variation of the present disclosure;

FIG. 4 is a schematic diagram illustrating an example of a bus according to an aspect of a variation of the present disclosure; and

FIG. 5 is a schematic diagram illustrating an example of a bus according to an aspect of a variation of the present disclosure.

### DESCRIPTION OF EMBODIMENTS

Hereinafter, an embodiment of the present disclosure will be described with reference to the drawings. Note that, in all the drawings, an element the same as a precedent element is given the same reference numeral, and the description thereof may be omitted.

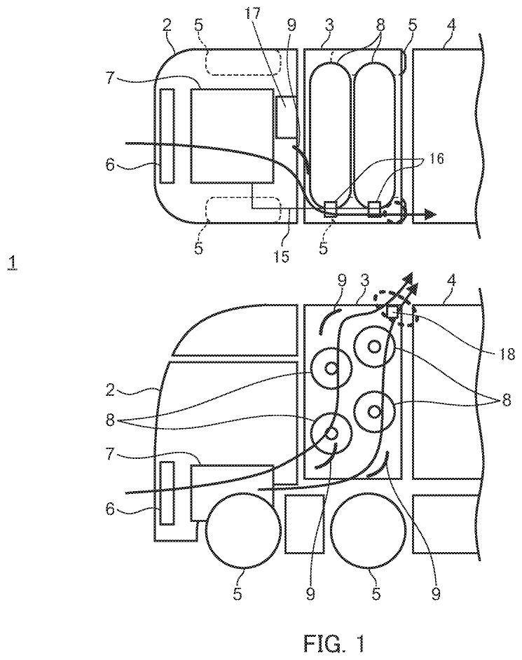

Truck 1 (an example of a fuel cell vehicle) according to the present embodiment will be described with reference to FIG. 1. FIG. 1 is a schematic diagram illustrating an example of truck 1 according to the present embodiment. In FIG. 1, the upper figure is a top view of truck 1, and the lower figure is a side view of truck 1. In FIG. 1, the left side of the figure is the front side of truck 1, and the right side of the figure is the rear side of truck 1.

As illustrated in FIG. 1, truck 1 includes cab 2, hydrogen tank chamber 3, cargo compartment 4, and wheels 5.

Radiator fan 6 (an exemplary blower) and Fuel Cell System (FCS) 7 are disposed below cab 2.

Hydrogen tank chamber 3 is, for example, a box-shaped housing. In hydrogen tank chamber 3, a plurality of hydrogen tanks 8 are arranged sideways (in other words, along the vehicle width direction).

Hydrogen (an example of fuel) is stored in each of hydrogen tanks 8. Each of hydrogen tanks 8 and fuel cell system 7 are connected to each other via pipe 15 (which may include joint 16). Thus, hydrogen in each hydrogen tank 8 is supplied to fuel cell system 7.

Fuel cell system 7 generates electric power using hydrogen supplied from hydrogen tanks 8. Although not illustrated, fuel cell system 7 includes a fuel cell stack and auxiliary devices (for example, an air-compressor, a DC-DC converter, and the like). Truck 1 is equipped with motor 17 that is driven by using the electric power supplied from fuel cell system 7. The driving of motor 17 causes truck 1 to travel.

Although the basic configuration has been described above, truck 1 of the present embodiment is characterized in that air guide plates 9 (an example of the guide member) are disposed as illustrated in FIG. 1. Air guide plates 9 are a member that guides the airflow so that the airflow flowing in the vehicle body of truck 1 passes through a component at high risk of leakage of hydrogen (for example, valves of hydrogen tanks 8 and/or a joint between other components).

Arrows illustrated in FIG. 1 illustrate an example of the airflow flowing through the vehicle body of truck 1. The airflow during when truck 1 is traveling refers to a wind caused during vehicle traveling and taken in from the front surface of cab 2 (for example, an outside air introduction port such as a front grille), and the airflow during when truck 1 is parked refers to the wind generated by the operation of radiator fan 6.

As illustrated in FIG. 1, the airflow first passes through fuel cell system 7. Fuel cell system 7 is installed at a position where the flow rate and the flow amount of the airflow are large.

Then, the airflow flows into hydrogen tank chamber 3. At this time, as illustrated in the upper figure of FIG. 1, the airflow is guided to the valve side of hydrogen tanks 8 by air guide plate 9 which is installed near the entrance of hydrogen tank chamber 3.

Next, as illustrated in the lower figure of FIG. 1, the air flow is divided by two air guide plates 9 which are installed at the lower side in hydrogen tank chamber 3, and is guided upward from the lower side in hydrogen tank chamber 3. At this time, the airflow passes through the valves of respective hydrogen tanks 8.

Next, as illustrated in the lower figure of FIG. 1, the airflow is guided by air guide plate 9 which is installed on the upper side in hydrogen tank chamber 3, so as to be smoothly discharged from an air discharge port (not illustrated) of hydrogen tank chamber 3 to the outside of truck 1.

As described above, in truck 1 of the present embodiment, by installing air guide plates 9, it is possible to guide the airflow flowing in the vehicle body such that the airflow passes through hydrogen tanks 8 at high risk of hydrogen leakage. Accordingly, the hydrogen leaked from hydrogen tanks 8 can be efficiently discharged to the outside of the vehicle. Further, since the airflow is rectified, it is possible to achieve reduction of the traveling resistance.

In addition, in truck 1 of the present embodiment, fuel cell system 7 at high risk of hydrogen leakage is installed at a position where the flow rate and the flow amount of the airflow are large. As a result, the fuel leaked from fuel cell system 7, that is, hydrogen, can be efficiently discharged to the outside of the vehicle.

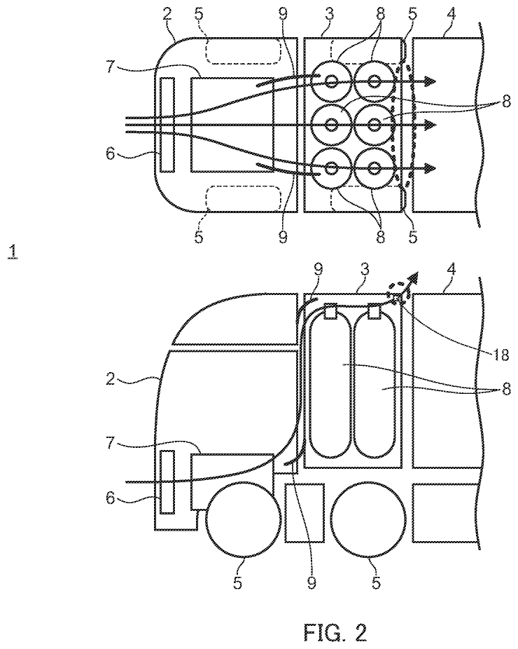

In the above description, the case in which hydrogen tanks 8 are disposed sideways has been described as an example, but the present invention is not limited thereto. A case where hydrogen tanks 8 are arranged vertically will be described with reference to FIG. 2. In FIG. 2, the same components as those in FIG. 1 are denoted by the same reference numerals.

As illustrated in the upper figure of FIG. 2, the airflow after passing through fuel cell system 7 is guided to hydrogen tank chamber 3 by two air guide plates 9 which are installed between cab 2 and hydrogen tanks 8, so as not to expand in the vehicle width direction.

Next, as illustrated in the lower figure of FIG. 2, the airflow is guided upward from the lower side in hydrogen tank chamber 3 by air guide plate 9 which is installed on the lower side in hydrogen tank chamber 3.

Next, as illustrated in the lower figure of FIG. 2, the airflow is guided to the valve side of hydrogen tanks 8 by air guide plate 9 which is installed on the upper side in hydrogen tank chamber 3, and is guided so as to be smoothly discharged from the air discharge port (not illustrated) of hydrogen tank chamber 3 to the outside of truck 1.

Truck 1 of the present embodiment has been described above.

Note that the present disclosure is not limited to the description of the above-described embodiment, and various modifications can be made without departing from the gist thereof. In the following, variations will be described.

### [Variation 1]

The shapes, installation positions, and installation number of air guide plates 9 are not limited to those in the description of the present embodiment. The air guide plates may be determined as appropriate such that the airflow passes through components at high risk of hydrogen leakage.

### [Variation 2]

In FIGS. 1 and 2, hydrogen sensor 18 may be disposed at a portion immediately in front of the portion where the airflow is discharged to the outside of the vehicle body (for example, in the vicinity of the air discharge port; see an ellipse indicated by a dotted line in FIGS. 1 and 2). Since hydrogen is collected and discharged by air guide plates 9, efficient detection by hydrogen sensor 18 can be achieved, and the number of hydrogen sensors 18 installed can be reduced.

### [Variation 3]

The embodiment has been described in relation to the exemplary case where fuel cell system 7 is disposed at a place where the flow rate and the flow amount of the airflow are large, but the present invention is not limited thereto. For example, a pipe joint (an example of the component at high risk of hydrogen leakage) may be disposed at the above-described place. In this case, it is not necessary to provide the pipe joint with a complicated component (for example, a highly airtight cover or the like) for suppressing hydrogen leakage.

### [Variation 4]

The embodiment has been described in relation to the exemplary case in which hydrogen tanks 8 are disposed in hydrogen tank chamber 3 which is a box-shaped housing, but the present invention is not limited thereto. For example, the plurality of hydrogen tanks 8 may be disposed on a rack or the like disposed on a flat table.

### [Variation 5]

The embodiment has been described in relation to the exemplary case in which the fuel cell vehicle is a truck, but the present invention is not limited thereto.

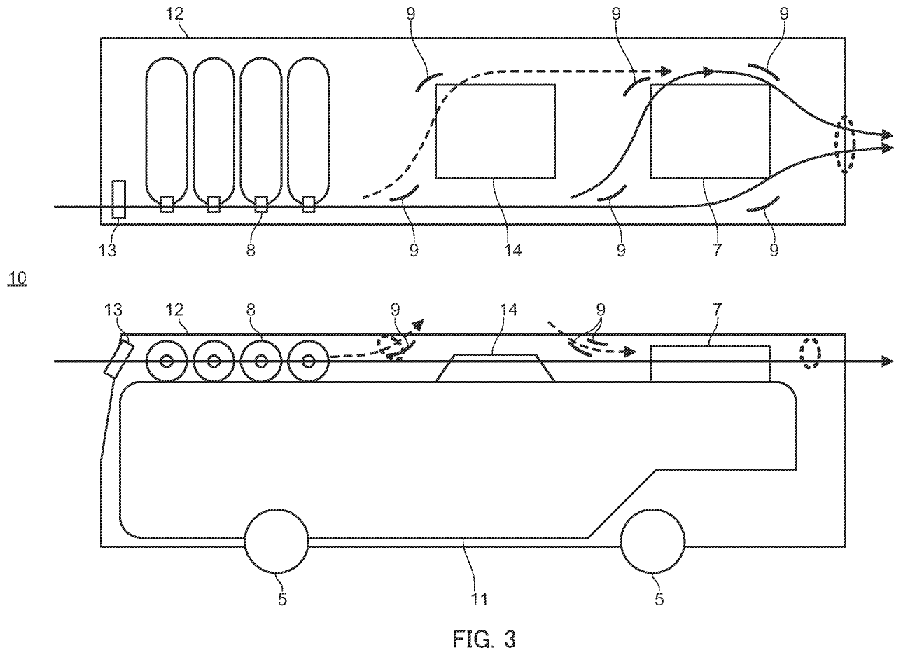

Hereinafter, a case where the fuel cell vehicle is a bus will be described with reference to FIGS. 3 to 5. FIGS. 3 to 5 are top views and side views illustrating first to third configuration examples of bus 10, respectively. In FIGS. 3 to 5, components common to those in FIGS. 1 and 2 are denoted by the same reference numerals. In FIGS. 3 to 5, the left side of the figures is the front side of bus 10, and the right side of the figures is the rear side of bus 10. In addition, arrows illustrated in FIGS. 3 to 5 each indicate an example of an airflow flowing through the vehicle body of bus 10.

To begin with, the first configuration example of bus 10 will be described with reference to FIG. 3.

Bus 10 has interior space 11 provided with a driver's seat, a passenger seat, and the like. Exterior space 12 is provided above interior space 11 along the vehicle length direction of bus 10.

Outside air introduction port 13 is disposed in the upper portion of the front surface of bus 10. Outside air introduction port 13 communicates with exterior space 12.

In exterior space 12, a plurality of hydrogen tanks 8, air conditioner 14, and fuel cell system 7 are installed in this order from the front side. Hydrogen tanks 8 are installed sideways. Further, a plurality of air guide plates 9 for guiding the airflow so as to cause the airflow to smoothly pass through air conditioner 14 and fuel cell system 7 (in other words, so as to cause the airflow not to collide with air conditioner 14 and fuel cell system 7 to stay still) are disposed in the vicinity of each of air conditioner 14 and fuel cell system 7 in exterior space 12.

The airflow (for example, wind caused during vehicle traveling) taken into exterior space 12 from outside air introduction port 13 passes through a valve of each hydrogen tank 8, passes through air conditioner 14 and fuel cell system 7, and is discharged into the atmosphere from an air discharge port (not illustrated) disposed on the downstream side of exterior space 12.

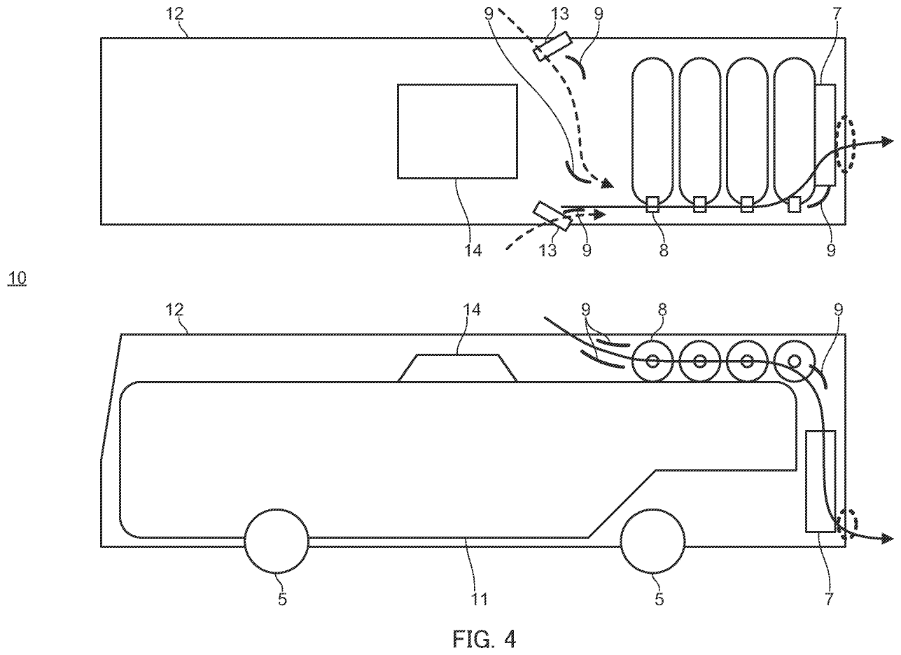

In FIG. 3, a hydrogen sensor may be disposed at a portion immediately in front of the portion where the airflow is discharged to the outside of the vehicle body (for example, in the vicinity of the air discharge port; see an ellipse indicated by a dotted line in FIG. 3). Next, a second configuration example of bus 10 will be described with reference to FIG. 4. In FIG. 4, components common to those in FIG. 3 are denoted by the same reference numerals.

In the present example, exterior space 12 is disposed above and behind interior space 11. A plurality of hydrogen tanks 8 are installed sideways in upper-side exterior space 12, and fuel cell system 7 is installed in rear-side exterior space 12. Two outside air introduction ports 13 are disposed on the rear side of air conditioner 14, and communicate with upper-side exterior space 12.

Further, a plurality of air guide plates 9 for guiding the airflow taken from outside air introduction ports 13 such that the airflow is directed to the valves of hydrogen tanks 8 and then smoothly passes through the valves and fuel cell system 7 (in other words, such that the airflow does not collide with hydrogen tank 8 and fuel cell system 7 to stay still) are disposed in the vicinity of outside air introduction ports 13, hydrogen tanks 8, and fuel cell system 7 in exterior space 12.

After the airflow (for example, wind caused during vehicle traveling) taken into exterior space 12 from outside air introduction ports 13 is directed to the valves of hydrogen tanks 8 and passes through the valves, the airflow passes through fuel cell system 7 and is discharged into the atmosphere from an air discharge port (not illustrated) disposed on the downstream side of exterior space 12.

In FIG. 4, a hydrogen sensor may be disposed at a portion immediately in front of the portion where the airflow is discharged to the outside of the vehicle body (for example, in the vicinity of the air discharge port; see an ellipse indicated by a dotted line in FIG. 4).

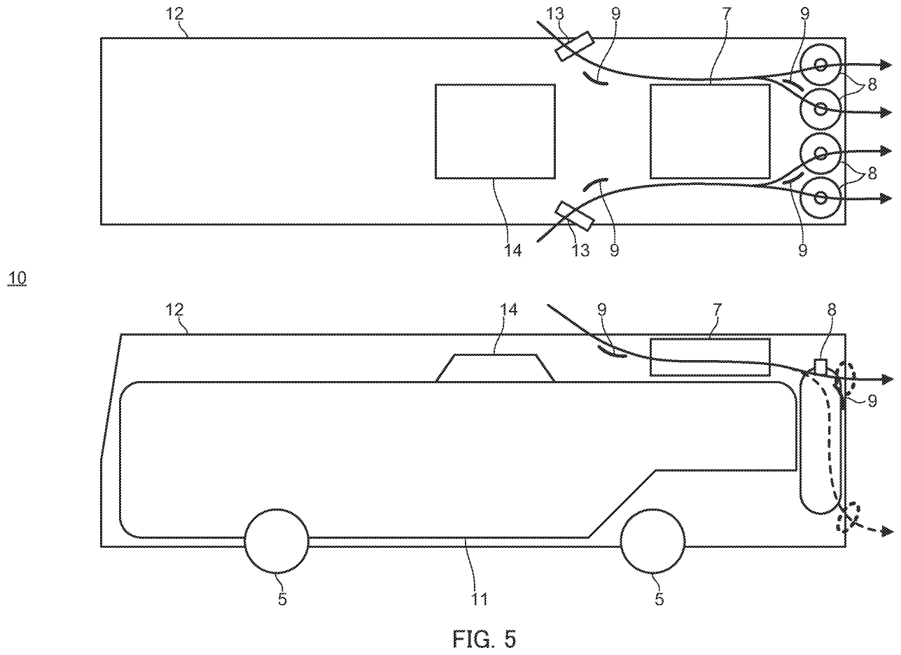

Next, a third configuration example of bus 10 will be described with reference to FIG. 5. In FIG. 5, components common to those in FIG. 3 are denoted by the same reference numerals.

In the present example, exterior space 12 is provided above and behind interior space 11. Fuel cell system 7 is installed in upper-side exterior space 12, and a plurality of hydrogen tanks 8 are vertically installed in rear-side exterior space 12. Two outside air introduction ports 13 are disposed on the rear side of air conditioner 14, and communicate with upper-side exterior space 12.

Further, a plurality of air guide plates 9 for guiding the airflow taken from outside air introduction ports 13 such that the airflow is directed to fuel cell system 7 and then smoothly passes through fuel cell system 7 and the valves of hydrogen tanks 8 (in other words, such that the airflow does not collide with fuel cell system 7 and hydrogen tanks 8 to stay still) are disposed in the vicinity of outside air introduction ports 13, fuel cell system 7, and hydrogen tanks 8 in exterior space 12.

After the airflow (for example, wind caused during vehicle traveling) taken into exterior space 12 from outside air introduction ports 13 is directed to fuel cell system 7 and passes through fuel cell system 7, the airflow passes through the valves of hydrogen tanks 8 and is discharged into the atmosphere from an air discharge port (not illustrated) disposed on the downstream side of exterior space 12.

In FIG. 5, a hydrogen sensor may be disposed at a portion immediately in front of the portion where the airflow is discharged to the outside of the vehicle body (for example, in the vicinity of the air discharge port; see an ellipse indicated by a dotted line in FIG. 5).

### INDUSTRIAL APPLICABILITY

The fuel cell vehicle of the present disclosure is useful for discharging leaked fuel to the outside of the vehicle.

1. A fuel cell vehicle equipped with a tank that stores fuel, a fuel cell system that generates electric power using the fuel, and a motor that is driven using the electric power generated by the fuel cell system, the fuel cell vehicle being configured to travel by driving of the motor, the fuel cell vehicle comprising:
a guide member configured to guide an airflow such that the airflow passes through a component at high risk of leakage of the fuel, the airflow flowing through a vehicle body of the fuel cell vehicle.

2. The fuel cell vehicle according to claim 1, wherein
the guide member is further configured to divide the airflow such that the airflow passes through each of a plurality of the components disposed.

3. The fuel cell vehicle according to claim 1, wherein
the guide member is further configured to guide the airflow such that the airflow is discharged to an outside of the vehicle body of the fuel cell vehicle after passing through the component.

4. The fuel cell vehicle according to claim 1, wherein
the component includes at least one of the tank, the fuel cell system, a joint of a pipe connecting between the tank and the fuel cell.

5. The fuel cell vehicle according to claim 1, wherein
the airflow is a wind caused during vehicle traveling and taken in from an outside air introduction port mounted on the fuel cell vehicle, or a wind generated by an operation of a blower mounted on the fuel cell vehicle.

6. The fuel cell vehicle according to claim 1, further comprising:
a hydrogen sensor at a portion immediately in front of where the airflow is discharged to an outside of the vehicle body.

7. The fuel cell vehicle according to claim 1, wherein
the fuel cell vehicle is a truck or a bus.
